(19) United States
(12) Patent Application Publication
(10) Pub. No.: US 2014/0214385 A1
(43) Pub. Date: Jul. 31, 2014

(54) AUTOMATIC ITEM GENERATION (AIG) MANUFACTURING PROCESS AND SYSTEM

(71) Applicants: Mark Gierl, Edmonton (CA); Hollis Lai, Edmonton (CA)

(72) Inventors: Mark Gierl, Edmonton (CA); Hollis Lai, Edmonton (CA)

(21) Appl. No.: 14/167,772

(22) Filed: Jan. 29, 2014

Related U.S. Application Data
(60) Provisional application No. 61/758,587, filed on Jan. 30, 2013.

(51) Int. Cl. G06F 17/50

(52) U.S. Cl. CPC G06F 17/50
USPC 703/6

(57) ABSTRACT

A process for generating test items comprising a templated approach through the use of cognitive modeling and item modeling.

### CROSS REFERENCE TO RELATED APPLICATION

This application claims benefit to U.S. Provisional Patent Application Ser. No. 61/758,587, filed Jan. 30, 2013.

### FIELD OF INVENTION

The present invention relates to educational assessment, and more specifically, to a method of and system for generating items for educational assessments.

### BACKGROUND OF THE INVENTION

Many educational assessments, which were once given in a paper-and-pencil format, are now administered by computer, often using the Internet, Ethernet or similar communication networks. Education Week's 2009 Technology Counts, for example, reported that 27 US states now administer Internet-based computerized educational assessments. Many popular and well-known exams in North America such as the Graduate Management Achievement Test (GMAT), the Graduate Record Exam (GRE), the Test of English as a Foreign Language (TOEFL iBT), and the American Institute of Certified Public Accountants Uniform CPA examination (CBT-e), to cite but a few examples, are administered by computer over the Internet.

Internet-based computerized assessment offers many advantages to students and educators compared to more traditional paper-based assessments. For instance, computers support the development of innovative item types and alternative item formats (Sireci & Zenisky, 2006; Zenisky & Sireci, 2002); items on computer-based tests can be scored immediately thereby providing students with instant feedback (Drasgow & Mattern, 2006); computers permit continuous testing and testing on-demand for students (van der Linden & Glas, 2010). But possibly the most important advantage of computer-based assessment is that it allows educators to measure more complex performances by integrating test items and digital media to substantially increase the types of knowledge, skills, and competencies that can be measured (Bartram, 2006; Zenisky & Sireci, 2002).

The advent of computer-based testing has also raised new challenges, particularly in the area of item development (Downing & Haladyna, 2006; Schmeiser & Welch, 2006). Large numbers of items are needed to develop the banks necessary for computerized testing because items are continuously administered and, therefore, exposed. As a result, these banks must be frequently replenished to minimize item exposure and maintain test security. Because testing agencies are now faced with the daunting task of creating thousands of new items for computer-based assessments, alternative methods of item development are desperately needed.

For example, many tests of medical knowledge, from the undergraduate level to the level of certification and licensure, contain multiple-choice items. Although these are efficient in measuring examinees' knowledge and skills across diverse content areas, multiple-choice items are time-consuming and expensive to create. Traditional item development using manual processes can be inefficient, largely because items are treated as isolated entities that are individually created, reviewed, and formatted. Because the items are individually authored, they yield unpredictable statistical outcomes (and, therefore, require field testing) because the incidental and radical elements are not easily identified or well understood. Traditional item development can also pose security risks for a testing program because the costs associated with construction, calibration, and maintenance limit the number of operational items that are available at any one time—with fewer operational items available, exposure risks may increase because more examinees are being exposed to each item. Drasgow, Luecht, and Bennett (2006, p. 473), in their seminal chapter in Educational Measurement (4th Edition) on technology and testing, provide this summary:
The demand for large numbers of items is challenging to satisfy because the traditional approach to test development uses the item as the fundamental unit of currency. That is, each item is individually hand-crafted—written, reviewed, revised, edited, entered into a computer, and calibrated—as if no other like it had ever been created before. A second issue with traditional approaches is that it is notoriously hard to hit difficulty targets, which results in having too many items at some levels and not enough at other levels. Finally, the pretesting needed for calibration in adaptive testing programs entails significant cost and effort.

Thus, there is for an improved method of and system for generating items for educational assessments.

### SUMMARY OF THE INVENTION

It is an object of the invention to provide an improved method of and system for generating items for educational assessments.

The purpose of the invention is to provide a manufacturing process and system to systematically create test items. This document sets out the logic that is required for item generation. The approach describe in this document is template-based, meaning that an item model is used to guide the generative process. An item model is comparable to a mould, rendering, or prototype that highlights the features in an assessment task that must be manipulated to produce new items. A three-step process is described to guide the production of test items. In step 1, the content used for item generation is identified by test development specialists in the form of a cognitive model (see Subsection 3.0). In step 2, an item model is developed to specify where content is placed in each generated item (see Subsections 1.0, 2.0 and 5.0). In step 3, computer-based algorithms are used to place the content specified in step 1 into the item model developed in step 2 (see Subsection 4.0). The three-step manufacturing process enables the generation of hundreds or even thousands of test items for a given model.

One embodiment of the invention comprises a system for generating test items comprising a computing device and an interface associated with said computing device. The interface may be operable to receive data defining a cognitive model. The computing device may be operable to place the cognitive model data into an item model and to execute a computer algorithm to randomly generate test items within the constraints of the item model. The communication network may make the generated test items available for testing in remote locations, and may comprise, for example, an Internet communication network, an Ethernet communication network or a similar wireless or hard-wired network. The system will typically store the randomly generated test items on a server, making them accessible to client computers.

Other systems, methods, features and advantages of the invention will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

These and other features of the invention will become more apparent from the following description in which reference is made to the appended drawings wherein:

FIG. 1 presents a flow diagram of an item generation manufacturing process in an embodiment of the invention;

FIG. 2 presents a diagram of a knowledge structure for item generation in an embodiment of the invention;

FIG. 3 presents a comparison of the elements in a 1-layer model to an n-layer item model in an embodiment of the invention;

FIG. 4 presents an exemplary item model in an embodiment of the invention;

FIGS. 5A and 5B present illustrations of IGOR interfaces, FIG. 5A presenting input panels and editing functions and FIG. 5B presenting the functions for a test item generator interface in an embodiment of the invention; and

FIG. 6 presents a flow diagram of an item generation manufacturing process in an embodiment of the invention.

### DETAILED DESCRIPTION

As explained above, recent attempts at providing automated test generation systems and methods have proven to be inadequate. Preferred systems and methods which address one or more of the problems known in the art are described hereinafter, by way of particular examples. It will be apparent to persons skilled in the art that a number of variations and modifications can be made without departing from the scope of the invention as defined in the claims.

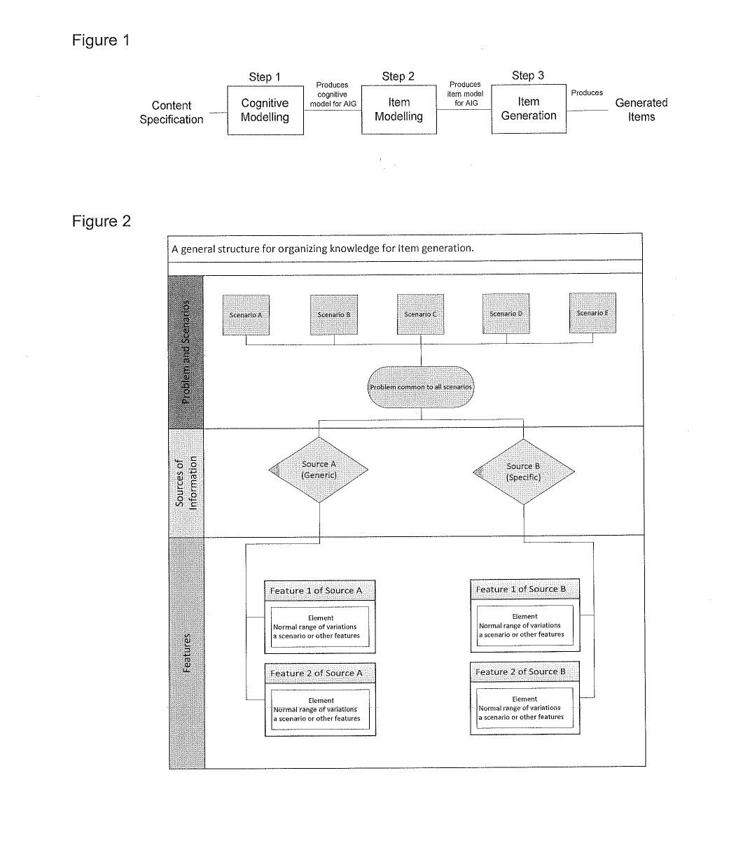

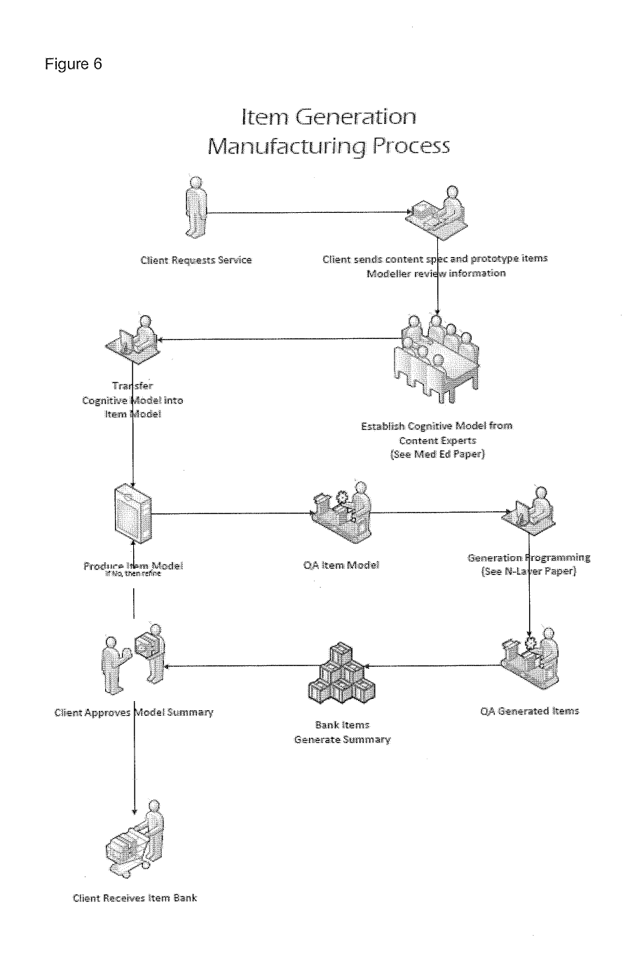

This document describes a manufacturing process for developing test items under a template-based generation process. The manufacturing process involves three distinct steps of development requiring the production of the three outcomes. The first step of the process involves the capturing of content expertise information in the form of a cognitive model. The second step of the process modifies the information presented in the cognitive model and operationalizes it into an item model. The third step of the process is enabled through programming, to automatically generate test items. An outline of this process is presented in FIG. 1, while a more detailed flow diagram is presented in FIG. 6. The flow diagram of FIG. 1 comprises the three following steps:

### STEP #1: Cognitive Model Development (see also, Subsection 3.0 which follows)

In this production step of test items generation, test development specialists are needed to select the content to be used for producing new items. Information for the new items are collected and organized in the form of a cognitive model, which is used to specify the content required to manipulate and generate items in later stages. This cognitive structure highlights information in three panels presented in FIG. 2 (see also Subsection 3.0). The first panel identifies the problem and its associated scenarios. The second panel specifies the relevant sources of information. The third panel highlights the salient features, which includes the elements and constraints, within the relevant sources of information specified in the middle panel. Elements contain content specific to each feature that can be manipulated for item generation. Each element is also constrained by the scenarios specific to this problem. Taken together, the first step of the manufacturing process produces cognitive models that serve as an explicit representation of the problem-solving knowledge and skills required to solve the content produced in the test item. The knowledge and skills specified in the cognitive model are identified in an inductive manner using a verbal reporting method. That is, the content specialists were given an existing multiple-choice item and asked to identify and describe the key information that would be used to solve the item. This representation was documented as a cognitive model and then used to guide the detailed rendering process needed for item generation.

### STEP #2: Item Model Development (see also Subsections 1.0, 2.0 and 3.0 which follow)

Item model development serves as the second step in the process (see also Subsection 1.0). Item models contain the components in an assessment task that can be used for item generation. These components include the stem, the options, and the auxiliary information. The stem contains context, content, item, and/or the question the examinee is required to answer. The options include a set of alternative answers with one correct option and one or more incorrect options or distracters. Both stem and options are required for multiple-choice item models. Only the stem is created for constructed-response item models. Auxiliary information includes any additional content, in either the stem or option, required to generate an item, including text, images, tables, graphs, diagrams, audio, and/or video. The stem and options can be further divided into elements. An element is the specific variable in an item model that is manipulated to produce new test items. An element is denoted as either a string, which is a non-numeric value or an integer, which is a numeric value. By systematically manipulating elements, new items can be created.

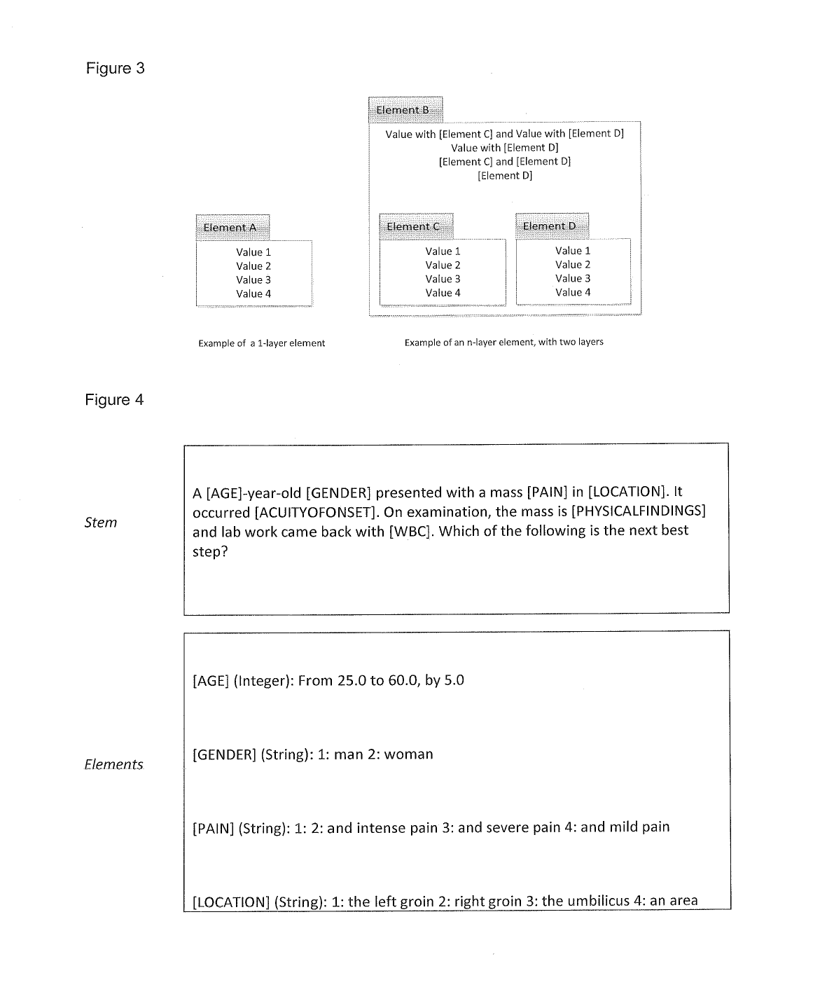

Two types of item models exist. Conventional item generation approaches create an item model with a single layer of elements, and produces new assessment tasks by manipulating the elements in the model. A second, alternative item model was invented which can be described as an n-layer item model (see Subsection 2.0). The goal of AIG using the n-layer item model is to produce items by manipulating a relatively large number of elements at two or more levels in the model. The starting point for the n-layer model is to use a parent item. But unlike the 1-layer model where the manipulations are constrained to a linear set of generative operations using a small number of elements at a single level, the n-layer model permits manipulations of a nonlinear set of generative operations, such as embedding elements within one another that allow the creation of elements at multiple levels. As a result, the generative capacity of the n-layer model is by design an improvement to the conventional 1-layer models. The n-layer structure can be described as a model with multiple layers of elements, where each element can be varied simultaneously at different levels to produce different items (hence, generation is described as nonlinear). A comparison of the 1-layer and n-layer item model is presented in FIG. 3. For this example, the 1-layer model can provide a maximum of four different values for element A (see left-side of figure). Conversely, the n-layer model can provide up to 64 different values by embedding the same four values for elements C and D within element B (see right-side of figure). Because the maximum generative capacity of an item model is the product of the ranges in each element (see also Subsection 5.0), the use of an n-layer item model will always increase the number of items that can be generated relative to a 1-layer structure. In this step of development, content expressed in the cognitive model is converted into an item model to allow for the generation of test items.

### STEP #3: Item Generation (see also Subsection 4.0)

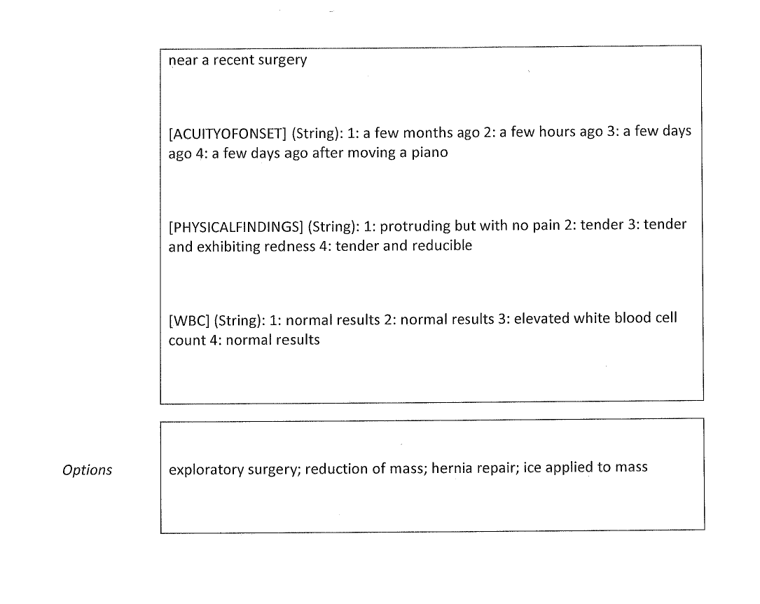

Once the content has been identified and the item models are created, this information is then assembled to produce new items as part of the third step in our three-step process. This assembly task must be conducted with some type of computer-based assembly system because it is a combinatorial problem. Gierl, Zhou, & Alves (2008), included herein as Subsection 4.0 developed an algorithm for content assembly called IGOR. IGOR, which stands for Item GeneratOR, is a JAVA-based program designed to assemble the content specified in an item model, subject to elements and constraints articulated in the cognitive model. Iterations are conducted with IGOR to assemble all possible combinations of elements and options, subject to the constraints. Without the use of constraints, all of the variable content (i.e., values for the integers and strings) would be systematically combined to create new items. Unfortunately, some of these items would not be sensible or useful. Constraints therefore serve as restrictions that must be applied during the assembly task so that meaningful items are generated. To begin, IGOR reads an item model in the form of an XML (Extensible Markup Language) file. The content for the item model is formatted according to the same structure shown in FIG. 4 (i.e., stem, elements, options).

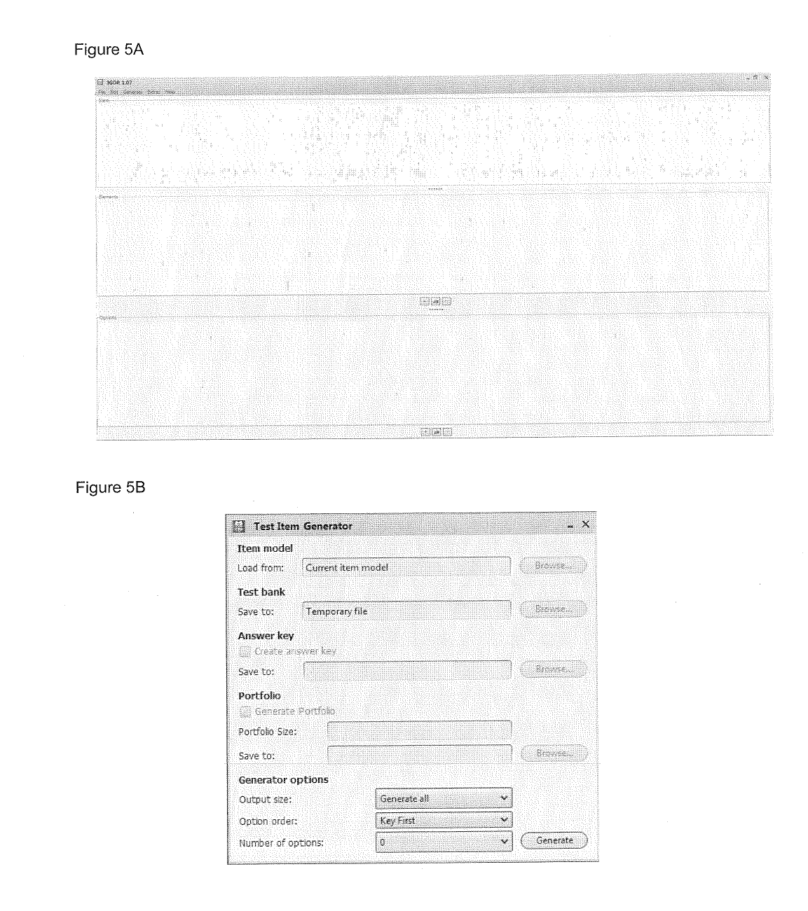

The exemplary Item Model Editor window of FIG. 5a permits the programmer to enter and structure each item model. The Item Model Editor has three panels. The stem panel is where the stem for the item model is specified. The elements panel is used to manipulate the integer and string variables as well as to apply the constraints highlighted in the cognitive model. The options panel is used to specify the correct and incorrect alternatives. The options are classified as either a key or a distracter. The Elements and Options panels contain three editing buttons. The first edit button allows the user to add a new element or option. The second edit button is used to modify the current element or option. The third edit button removes the selected element or option from the model.

To generate items from a model, the Test Item Generator dialogue box is presented where the user specifies the item model file, the test bank output file, the answer key file, a portfolio output, and the Generator options (see FIG. 5b). For the current example, the item model file is loaded from the current item model which is specified as an XML file. For the test bank output file, the user selects the desired location for the generated items. The user can also save a separate key under the answer key option. The Portfolio is used to generate a file containing all IGOR input as well as a sample of the generated item output. Portfolio Size refers to the number of generated items that will be included in the portfolio and the location of the portfolio output is specified in the “Save to” location. Finally, the user can specify Generator options. These options include size of the generated item bank, the order of the options, and the number of options for each generated item. Once the files have been specified in the Test Item Generator dialogue box, the program can be executed by selecting the ‘Generate’ button (see bottom right-side).

IGOR is a software application that allows the production of test items given the input of an item model. The third step of the manufacturing process utilizes outcomes from the previous steps and produce test items by instantiating all possible element combinations. The output of IGOR is a set of test items generated from the requirements of the item model. While the process of generating items have been attempted with different combination of technologies and processes. We contend the steps described in our manufacturing process, used in the particular order and of the formatting resources in the manner as we specified, will produce test items in a scale and quality as demanded by test developers.

### Conclusions

One or more currently preferred embodiments have been described by way of example. It will be apparent to persons skilled in the art that a number of variations and modifications can be made without departing from the scope of the invention as defined in the claims.

The method steps of the invention may be embodiment in sets of executable machine code stored in a variety of formats such as Object code or source code. Such code is described generically herein as programming code, or a computer program for simplification. Clearly, the executable machine code may be integrated with the code of other programs, implemented as subroutines, by external program calls or by other techniques as known in the art.

The embodiments of the invention may be executed by a computer processor or similar device programmed in the manner of method steps, or may be executed by an electronic system which is provided with means for executing these steps. Similarly, an electronic memory medium such computer diskettes, CD-Roms, Random Access Memory (RAM), Read Only Memory (ROM) or similar computer software storage media known in the art, may be programmed to execute such method steps. As well, electronic signals representing these method steps may also be transmitted via a communication network.

All citations are hereby incorporated by reference.

Further details of the invention are set forth in the following subsection numbers 1.0-6.0, and the following claims.

What is claimed is:

1. A process for generating test items comprising a templated approach through the use of cognitive modeling and item modeling.

2. The process of claim 1 wherein the item modeling comprises producing an n-layer item model.

3. The process of claim 1 wherein the n-layer item model permits manipulations of a nonlinear set of generative operations using elements at multiple levels.

4. The process of claim 1 comprising compartmentalizing each step into a separate systematic process, the steps including cognitive modeling, item modeling and item generation.

5. The process of claim 1 comprising compartmentalizing each step into a separate systematic process, the steps including:
developing a construct map;
developing task-level instructions; and
generating items.

6. The process of claim 1 wherein item modeling comprises constraining item templates using weak theory, to ensure a predetermined level of item difficulty.

7. The process of claim 1 wherein item modeling comprises constraining item templates using strong theory, to ensure a predetermined level of item difficulty.

8. A method of producing a cognitive model comprising:
defining a problem scenario;
identifying sources of information for said problem; and
logically interrelating elements and constraints of said sources of information which define said problem scenario.

9. The method of claim 8 wherein logically interrelating elements and constraints comprises:
logically and mathematically interrelating elements and constraints of said sources of information which define said problem scenario.

10. The method of claim 9 comprising production of N-layer item models, or other instances of which elements of an item model is manipulated in an instantiated or embedded manner, in multiple layers, for the purposes of test item development.

11. The method of claim 10 wherein the n-layer item model is applied to a template-based item generation method, to generate different item types.

12. The method of claim 8 comprising test item development comprising producing an N-layer item model, in which elements of the item model are manipulated in an instantiated or embedded manner, in multiple layers.

13. The method of claim 1 comprising the use of a task specific software for item generation, to produce test items based upon the input of an item model as specified.

14. The method of claim 13 wherein the use of task specific software comprises:
generating a set of all possible items; and
checking the constraints of each generated item and removing illogical element combinations.

15. A method of generating test items comprising:
developing a cognitive model;
developing an item model, schema, blueprint, template, form, frame, clone or shell; and
using a computer algorithm to place the content of the cognitive model into the item model.

16. The method of claim 15, wherein the item model further comprises auxiliary material including digital media such as text, images, tables, diagrams, sound, and/or video.

17. The method of claim 15 further comprising generating test items by varying the value of variables in said item model.

18. A system for generating test items comprising:
a computing device; and
an interface associated with said computing device;
said interface being operable to receive data defining a cognitive model; and
said computing device being operable:
to place said cognitive model data into an item model; and
to execute a computer algorithm to randomly generate test items within the constraints of said item model.

19. The system of claim 18, further comprising a communication network for making said generated test times available for testing in remote locations.

20. The system of claim 18, wherein said randomly generate test items are stored on a server, and said randomly generate test items are accessed via client computers.
